(19) United States
(12) Patent Application Publication
(10) Pub. No.: US 2023/0383692 A1
(43) Pub. Date: Nov. 30, 2023

(54) Internal Combustion Engine with Planetary Piston Gears

(71) Applicant: Frank J. Ardezzone, Santa Clara, CA (US)

(72) Inventor: Frank J. Ardezzone, Santa Clara, CA (US)

(21) Appl. No.: 18/233,851

(22) Filed: Aug. 14, 2023

Related U.S. Application Data
(62) Division of application No. 15/595,751, filed on May 15, 2017, now Pat. No. 11,028,771.
Application No. 15/595,751 is a continuation-in-part of application No. 17/340,508, filed on Jun. 7, 2021, now Pat. No. 11,725,576.
(60) Provisional application No. 62/336,754, filed on May 16, 2016.

(51) Int. Cl. F02B 75/22; F01B 1/06; F01B 1/12; F02B 75/32

(52) U.S. Cl. CPC F02B 75/222; F01B 1/0624; F01B 1/12; F02B 75/32; F01B 9/06

(57) ABSTRACT

A internal combustion engine (10) comprising a cam crank assembly (75) having a planetary gear assembly (2900), an intake cam (90) and an exhaust cam (92), the planetary gear assembly (2900) having drive gear (2910) rotationally secureable to the crank shaft (22), a piston gear (2912) rotationally engaged with the drive gear (2910), and a piston assembly (70) rotationally attached to the piston gear (2912).

### CROSS-REFERENCE TO RELATED APPLICATIONS

This application claims the benefit of U.S. application Ser. No. 15/595,751, filed on May 15, 2017, by the present inventor, issued as U.S. Pat. No. 11,028,771 on Jun. 8, 2021, entitled “Modular Internal Combustion Engine with Adaptable Piston Stroke,” and U.S. patent application Ser. No. 17/340,508, by the present inventor, issued as U.S. Pat. No. 11,725,576 on Aug. 14, 2023, entitled “Internal Combustion Engine with Adaptable Piston Stroke,” which both are hereby incorporated by reference in their entirety for all allowable purposes, including the incorporation and preservation of any and all rights to patentable subject matter of the inventor, such as features, elements, processes and process steps, and improvements that may supplement or relate to the subject matter described herein.

### STATEMENT REGARDING FEDERALLY SPONSORED RESEARCH OR DEVELOPMENT

Not Applicable

### BACKGROUND OF THE INVENTION

This invention relates generally to internal combustion engines, and more specifically to modular internal combustion engines with a controllable piston stroke cycle. Though previous designs may attempt to control the stroke pattern of a reciprocating piston of an internal combustion engine, they fail to effectively ameliorate all the forces that may impede the implementation of a cam-driven piston. Additionally, none of the systems address the entire internal combustion problem, as that they do not address the design of other systems needed to support internal combustion, such as air, fuel or cooling systems. Further, none of the systems provide for convenient modular expansion of a base block and piston assembly, but instead rely on adding additional pistons around the circumference of the drive cam, which would require total engine remanufacturing. It would be a valuable addition to the art, among other things, to provide a compact, integrated internal combustion engine system, that is modularly expandable by combining similar block and piston assemblies, as desired, after the block and piston assemblies are already manufactured.

### BRIEF DESCRIPTION OF THE DRAWINGS

FIG. 1 is an oblique top frontal view of an exemplary engine according to the present invention.

FIG. 2 is an oblique top rear view of the engine in FIG. 1.

FIG. 3 is an oblique top rear view of the engine in FIG. 1, without a fuel supply subsystem, according to the present invention.

FIG. 4 is an oblique rear view of the bell housing of the engine in FIG. 1.

FIG. 5 is an oblique front view of a thrust bearing plate of the engine in FIG. 1.

FIG. 6 is an oblique rear view of a thrust bearing plate shown in FIG. 5.

FIG. 7a is an oblique front view of the engine block and manifold in FIG. 1 with the bell housing and thrust bearing plate removed.

FIG. 7b is an oblique front view of alignment plates seated within exemplary engine block for FIG. 7a.

FIG. 8a is a normal front view of the engine in FIG. 1, cut so as to show cylinders and pistons of an engine bank.

FIG. 8b is a side view of the engine shown in FIG. 8a, cut at the line A-A.

FIG. 8c is a side view of the engine shown in FIG. 8a, cut at the line B-B.

FIG. 8d is a side view of the engine block assembly shown in FIG. 8b.

FIG. 8e is a cut-through side view of a detailed portion of a cam crank assembly.

FIG. 9a is a normal front view of an alternate engine embodiment of the current disclosure, cut so as to show cylinders and pistons of an engine bank.

FIG. 9b is a side view of the engine shown in FIG. 9a, cut at the line F-F.

FIG. 10 is an oblique front view of the engine block and manifold in FIG. 1, cut through the engine block assembly at line C-C, shown in FIG. 8d.

FIG. 11 is an oblique front view of the engine block and manifold in FIG. 1, cut through the engine block assembly at line D-D, shown in FIG. 8d.

FIG. 12 is an oblique front view of the engine block and manifold in FIG. 1, cut through the engine block assembly at line E-E, shown in FIG. 8d.

FIG. 13 is an oblique front view of an exemplary manifold rear mounting plate.

FIG. 14 is an oblique rear view of the engine in FIG. 1 with a portion of the manifold assembly removed to expose the rear of the manifold rear mounting plate shown in FIG. 13.

FIG. 15 is an oblique front view of an exemplary manifold channel plate.

FIG. 16 is an oblique rear view of the engine in FIG. 1 with a portion of the manifold assembly removed to expose the rear side of the manifold channel plate.

FIG. 17 is an oblique rear view of the engine in FIG. 1 with a portion of the manifold assembly removed to expose the rear of an exemplary manifold separation plate.

FIG. 18 is an oblique front view of an exemplary coolant plate.

FIG. 19 is an oblique rear view of the engine in FIG. 1 with a portion of the manifold assembly removed to expose the rear of the coolant plate shown in FIG. 18.

FIG. 20 is an oblique rear view of the engine in FIG. 1 showing an exemplary rear plate of the manifold installed on the coolant plate.

FIG. 21 is an oblique perspective view of an exemplary ignition system mounted on the rear of the engine in FIG. 1.

FIG. 22 is an oblique perspective view of an exemplary stator for the ignition system in FIG. 21.

FIG. 23 is an oblique perspective view of the rear of an exemplary rotor for the ignition system in FIG. 21.

FIG. 24 is a normal view illustration of the front of the exemplary rotor in FIG. 23.

FIG. 25 is an oblique perspective view of an exemplary integrated coil for the ignition system in FIG. 21.

FIG. 26a is a schematic illustration of an expanded modular engine with a supplemental engine block.

FIG. 26b is a schematic illustration of an engine bolt and an alternate embodiment engine bolt.

FIG. 27 is a side view of an alternate exemplary embodiment of an engine according to the present invention cut through the shaft axis.

FIG. 28 is a flow diagram of an exemplary process for adding a supplemental engine block to an engine.

FIG. 29 is an oblique perspective view of an exemplary planetary piston gear assembly according to the present invention.

FIG. 30 is a normal side view of the exemplary planetary piston gear assembly of FIG. 29.

FIG. 31 is an alternate side view of the planetary piston gear assembly shown in FIG. 30, cut at line G-G.

FIG. 32 is an oblique perspective view of an exemplary tandem planetary piston gear assembly according to the present invention.

FIG. 33 is an oblique perspective view of an alternate exemplary tandem planetary piston gear assembly where one gear assembly may be counter-rotated according to the present invention.

FIG. 34 is an oblique perspective view of an alternate exemplary planetary piston gear assembly according to the present invention.

FIGS. 35a through 35v are illustrations of configurations of various exemplary embodiments of the modular engine according to the present invention.

### DESCRIPTION OF THE PREFERRED EMBODIMENT

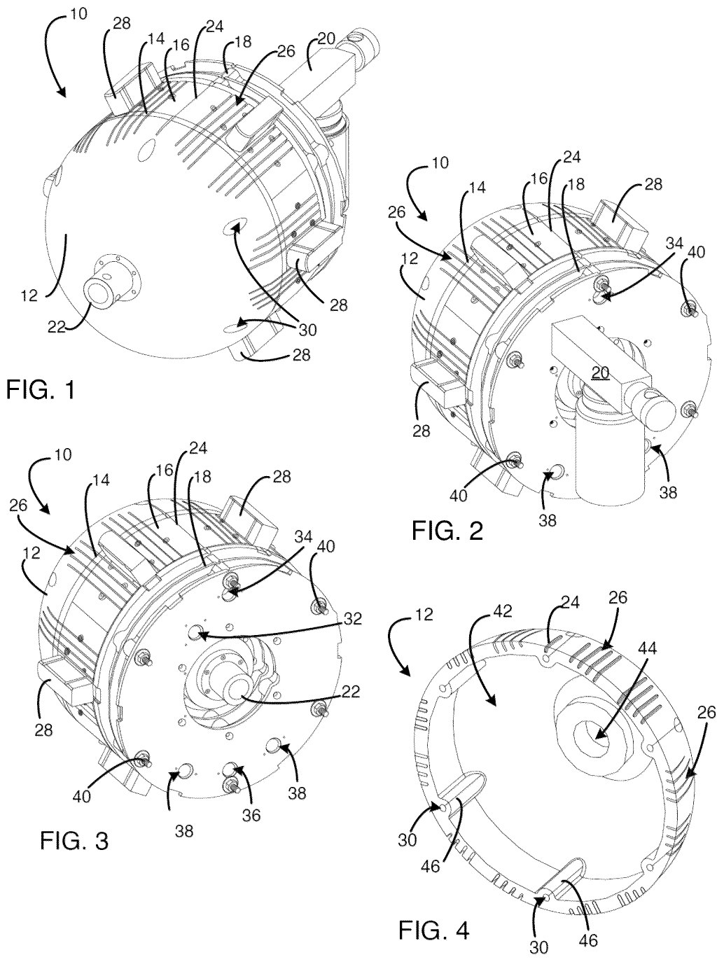

An exemplary internal combustion engine 10 is initially shown in FIGS. 1-3, comprising the components of a bell housing 12, thrust bearing plate 14, an engine block 16, the manifold assembly 18, and a shaft 22. For the convenience of a standard convention, the side of the engine 10 from which the shaft 22 protrudes from the bell housing 12, will be referred to herein as the “front” of the engine, since it is envisioned to be a suitable orientation for use of the engine 10 in an aviation application. As such, the side with the manifold assembly 18 will be referred to herein as the “rear” of the engine.

In the exemplary embodiment, a top groove 24 is provided, which may assist in alignment of the engine 10 components during assembly, and housing grooves 26 may assist in the removal of heat from the engine 10. When referring to the engine 10 as a whole or substantial whole, the “top” will refer to the side with the top groove 24. As will be seen in the future drawings, both the top groove 24 and the housing grooves 26 may be embodied in the peripheral surface of the individual sections, including the bell housing 12, thrust bearing plate 14, engine block 16, and components of the manifold assembly 18. Additionally, the exemplary embodiment may have a plurality of spark plug covers secured to the surface of the engine block 16 to protect the top of the spark plugs (not shown) and ignition wiring (not shown).

In the exemplary embodiment, an exemplary vaporator 20 is shown as an air-fuel mixture delivery system mountable to the rear of the manifold assembly 18, at a fuel mixture intake orifice 32. It is envisioned that the engine 10 may also have the capacity to use a conventional air-fuel mixture delivery system (not shown), including turbocharged or supercharged versions. In the exemplary embodiment, a plurality of assembly bolt channels 30 are contained within the bell housing 12. Exemplary assembly bolts 40, which may include an assembly washer and nut, may be positioned in the assembly bolt channels 30 to extend through the engine 10 to the rear of the manifold assembly 18. The exemplary assembly bolts 40 may be secured in place to hold the components of the engine 10 together. The rear of the manifold assembly 18 also may have a coolant fill orifice 34, a coolant drain orifice 36, and at least one exhaust orifice 38.

Referring now also to FIG. 4, an exemplary embodiment of a bell housing 12 is shown from the rear side, exposing the interior bell housing void 42. The bell housing void 42 may provide space for gearing (not shown) on shaft 22, which gearing could facilitate adjustable from shaft 22. In this depiction, a shaft hole 44 is illustrated, through which the shaft 22 may protrude, and in which the shaft 22 may freely rotate. Additionally, a plurality of assembly bolt housings 46, which surround and provide structural support for the assembly bolt channels 30, may also exist.

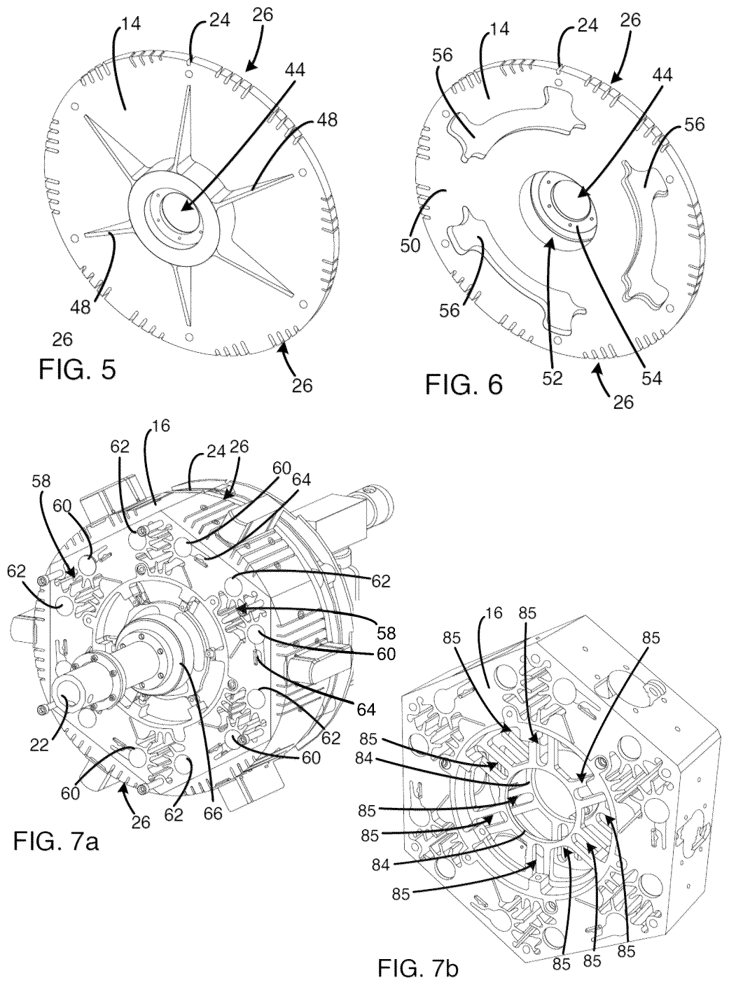

Referring to primarily FIGS. 5 and 6, an exemplary thrust bearing plate 14 is independently displayed to more clearly show the shaft hole 44 and the structure strut supports 48 on the front side of the exemplary thrust bearing plate 14. On the rear side of the thrust bearing plate 14 the engine 10 may have an exemplary engine block contact surface 50, which will snugly secure to the engine block 16. In the exemplary embodiment, a bearing recess 52 is positioned to surround the shaft hole 44. A recess contact face 54 is located within the bearing recess 52, and provides an appropriate surface to contact a bearing positioned on the shaft 22. Additionally, the exemplary engine block contact surface 50 may have a plurality of coolant recesses 56 that provide fluid communication of coolant between sections of a coolant jacket that may be formed within the engine block 16.

Referring primarily to FIG. 7a, a front side is shown of an exemplary engine block 16. The exemplary engine block 16 may have a flat front side and a flat rear side. The exemplary engine block 16 has a generally cylindrical exterior, because it is a radial design. The current teachings may be adapted for an engine 10 with a rectangular design.

The front side may abut snugly to the engine block contact surface 50 of the thrust bearing plate 14. A snug seal between the engine block 16 and the thrust bearing plate 14 facilitates the retention of pressures and fluids within the engine 10. The exemplary engine block 16 may have a plurality of coolant jacket sections 58 positioned radially around the shaft 22. In the exemplary embodiment, pairs of coolant jacket sections 58 are in fluid communication via a coolant recess 56. In the exemplary embodiment, where the front side of the engine block 16 abuts to the thrust bearing plate 14, intake channel plugs 60 and exhaust channel plugs 62 may be used to seal the respective front ends of intake channels (described and shown below and in later figures) and exhaust channels (described and shown below and in later figures). However, an effective seal against the ending block coolant surface 50 may adequately seal the intake and exhaust channels. The exemplary engine block 16 also may have exemplary valve retainer slots 64, which receive valve assembly retainer clips (described and shown below and in later figures) to secure a valve assembly (described and shown below and in later figures) in the engine block 16. In the exemplary embodiment, a thrust bearing 66 is positioned at the front end of an engine block 16, intermediate the engine block 16 and the thrust bearing plate 14.

Referring now also to FIG. 7b, an alternate front view is shown of an exemplary engine block 16 with portions of the engine assembly removed to show exemplary alignment plates 84. The engine block 16 may house an alignment plate 84. Alignment plates 84 may have a plurality of alignment channels 85. In the exemplary embodiment, a pair of alignment plates 84 are positioned parallel to each other, with pairs of their alignment channels 85 radially aligned.

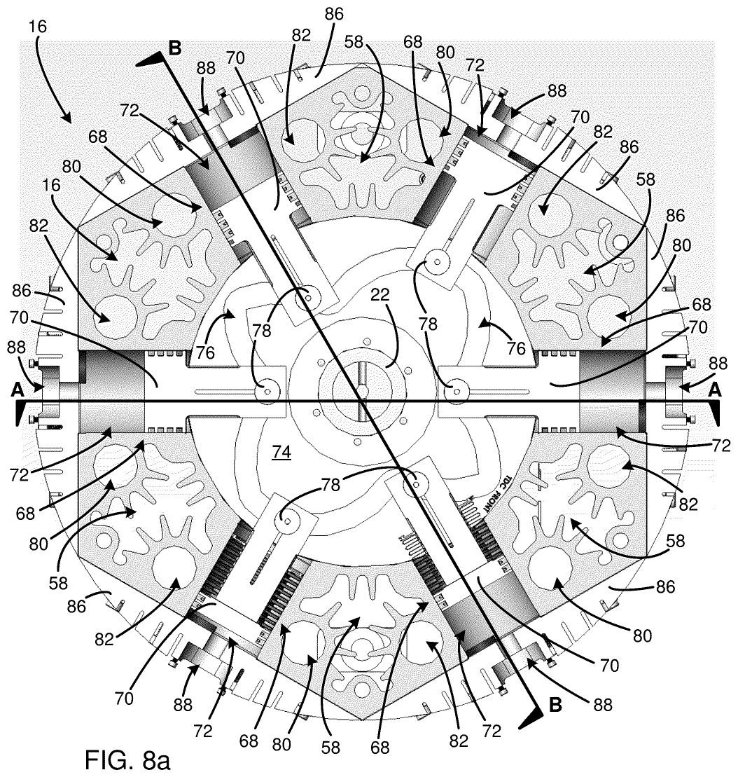

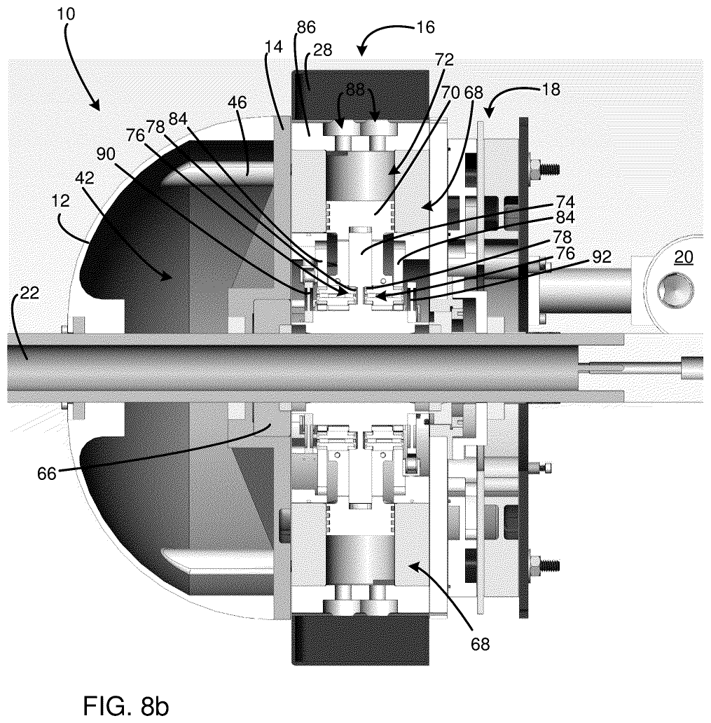

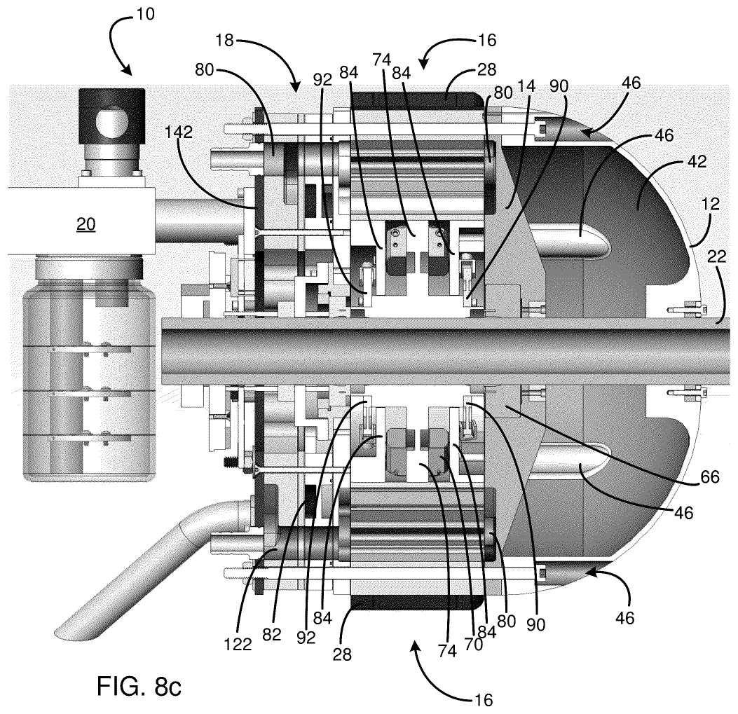

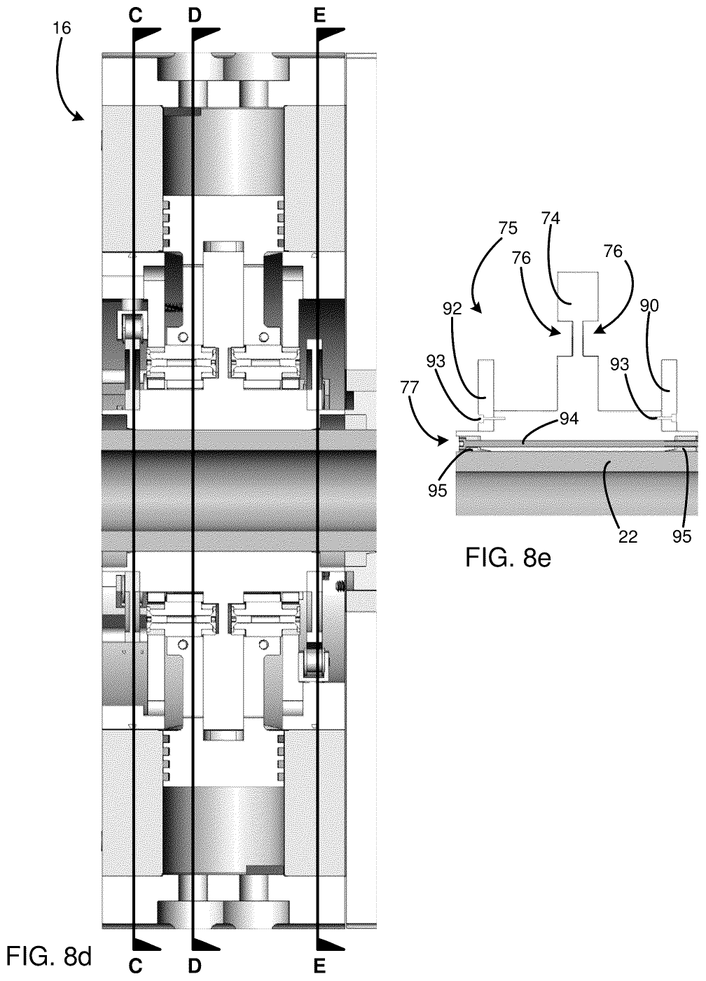

Referring now also to FIG. 8a, an exemplary engine 10 is shown cut perpendicular to the shaft 22 through the exemplary engine block 16 to show the exemplary configuration of the cylinders 68. The exemplary embodiment houses six cylinders 68, but the concept may accommodate fewer or more cylinders 68 in each engine block 16. Each exemplary cylinder comprises a piston assembly 70 positioned to slide linearly within a combustion chamber 72. It is envisioned that an engine block 16 may have a single cylinder 68, if the piston assembly 70 is appropriately counter-weighted.

The exemplary pistons are arranged around a cam crank 74. The cam crank 74 may have a precisely patterned piston crank groove 76 formed into a surface of the cam crank 74. In the exemplary embodiment, corresponding piston crank grooves 76 are positioned on each side of the cam crank 76. A piston traveler 78 is connected to the piston, and positioned in a piston crank groove 76. The precise pattern of the piston crank groove 76 communicates a desired piston assembly 70 position within the combustion chamber 72 through the piston traveler 78. When the piston moves toward the shaft 22, the piston traveler 78 pushes on the cam crank 74 to slide along the piston crank groove 76, forcing the cam crank 74 and the attached shaft 22 to rotate about the axis of the shaft 22.

An alignment plate 84 may provide support against forces that may push on a piston assembly 70 outwardly of a desired position within the cylinder 68. In the exemplary embodiment, alignment plates 84 may be positioned on opposite sides of the cylinders 68. A piston assembly 70 may have additional piston travelers 78 position so as to occupy alignment channels 85 in piston guide plates 84. In the exemplary embodiment, exemplary alignment channels 85 may be radially aligned with a respective cylinder 68, as well as a respective piston assembly 70. In the exemplary embodiment, the alignment plate 84 may be parallel to the cam crank 74. In the exemplary embodiment, alignment channel 85 may restrict the movement of the piston assembly 70 to stay within the cylinder 68, while the piston crank groove 76 of the cam crank 74 forces the piston assembly 70 to move outwardly and inwardly with respect to the shaft 22. The combination of the alignment channels 85 and the piston crank groove 76 result in defining a stroke pattern of piston assembly 70 within a respective cylinder 68.

Fuel mixture may be channeled to a combustion chamber 72 via a respective intake channel 80. Similarly, the exhaust created by combustion may be channeled out of the combustion chamber 72 via a respective exhaust channel 82. Each intake channel 80 is in fluid communication with the fuel mixture intake orifice 32 and a respective combustion chamber 72. Similarly, each exhaust channel 82 is in fluid communication with a respective combustion chamber 72 and an exhaust orifice 38.

At the top of each cylinder 68 may be a cylinder head 86, which can be removed to access a respective piston assembly 70 and combustion chamber 72. Each cylinder head 86 may have a spark plug well 88 formed there through, to receive and hold in position an appropriate sparkplug (not shown) so as to be able to provide an igniting spark within the combustion chamber 72.

Referring now also to FIG. 8b, an exemplary engine 10 is shown cut through middle along the shaft 22, so as to show another angle of the internal features of the components. A bell housing void 42 is seen within the bell housing 12. Additionally, at least one assembly bolt housing 46 is shown, which houses the assembly bolt channels 30 through the bell housing 12. The exemplary engine block 16 is cut through a pair of opposing cylinders 68 to show a piston assembly 70, combustion chamber 72, piston traveler 78, cylinder head 86, and an exemplary pair of spark plug wells 88 for each cylinder 68. Additionally, the illustration shows a cam crank 74 on shaft 22, in which is formed a piston crank groove 76. Similarly positioned on the shaft 22 as the cam crank 74 is an exemplary intake cam 90 toward the front of engine 10 from the cam crank 74, and an exemplary exhaust cam 92 toward the rear of the engine 10 from the cam crank 74.

Referring now also to FIG. 8c, an exemplary engine 10 is shown cut through middle along the shaft 22, so as to show another angle of the internal features of the components. A bell housing void 42 is seen within the bell housing 12. Additionally, at least one assembly bolt housing 46 is shown, which houses the assembly bolt channels 30 through the bell housing 12. The exemplary engine block 16 is cut through a pair of opposing cylinders 68 to show a piston assembly 70, and combustion chamber 72 for each cylinder 68. Additionally, the illustration shows a cam crank 74 on shaft 22. An exemplary intake cam 90 is similarly positioned on the shaft 22 as the cam crank 74. The exemplary intake cam 90 is positioned toward the front of engine 10 from the cam crank 74, and an exemplary exhaust cam 92 is positioned toward the rear of the engine 10 from the cam crank 74.

Referring now also to FIGS. 8d, a portion an exemplary engine block 16 is shown cut through middle along the shaft 22, and annotated with view that depict the approximate view perspective of later figures. Referring now also to FIGS. 8e, an exemplary cam crank assembly 75 is shown with particular detail to an exemplary shaft securement assembly 77. Exemplary cam crank assembly 75 may comprise a cam crank 74, an intake cam 90, and an exhaust cam 92. In the exemplary embodiment, intake cam 90 and exhaust cam 92 are removably attached parallel to the cam crank 74, on opposing sides of the cam crank 74, by mounting screws 93. The exemplary cam crank assembly 75 encircles the shaft 22, coaxial to and perpendicular to the rotatable axis of the shaft 22.

In the exemplary embodiment, the cam crank assembly 75 may be secured to the shaft 22 by a shaft securement assembly 77. The exemplary shaft securement assembly 77 may comprise a securing bolt 94, and a tapered bushing 95. In the exemplary embodiment, a plurality of securing bolts 94 extend from a side of the intake cam 90 distal the exhaust cam 92 through the intake cam 90, cam crank 74, and exhaust cam 92, to be secured in place on the opposite side of exhaust cam 90. The exemplary securing bolt 94 secures a tapered bushing 95 on the side of each the intake cam 90 and the exhaust cam 92 distal the cam crank 74. So configured, as the securing bolt 94 is tightened against the tapered bushings 95, the tapered bushings 95 are drawn inward, toward the cam crank 74, wedging the tapered body of the tapered bushing 95 between the cam crank assembly 75 and the shaft 22, removably securing the cam crank assembly 75 to the shaft 22.

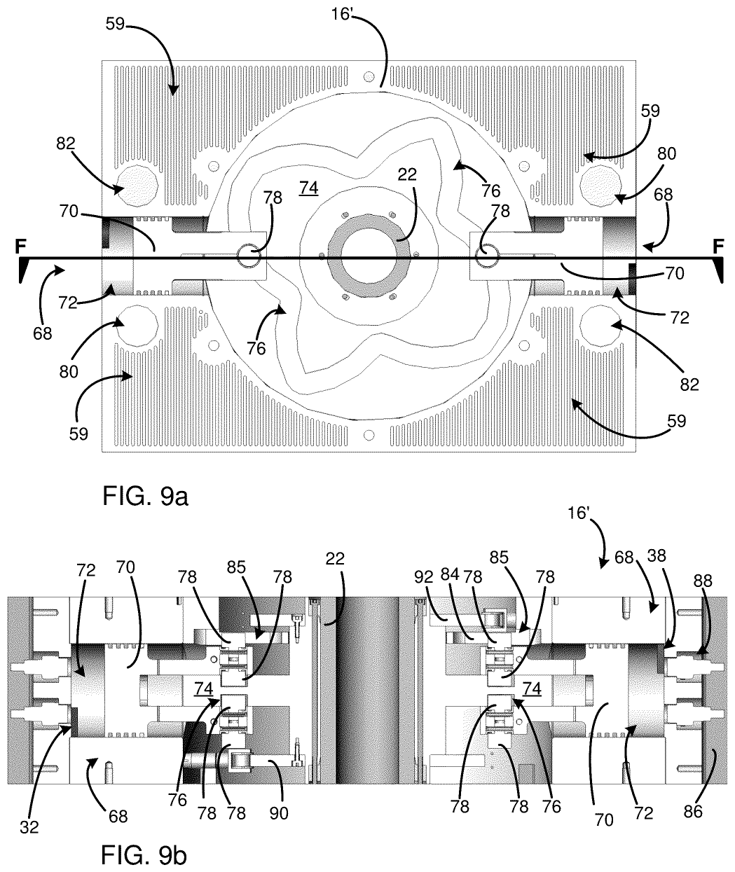

Focusing now on FIG. 9a, an alternate exemplary block 16′ is shown cut perpendicular to the shaft 22. The exemplary embodiment may have a single pair of opposed cylinders 68, which configuration will be referred to herein as an “opposed” configuration to differentiate this single-pair configuration from the preciously described radial configuration that also may have pairs of opposed cylinders 68. In the exemplary embodiment, each exemplary cylinder 68 comprises a piston assembly 70 positioned to slide linearly within a combustion chamber 72. It is envisioned that an engine block 16′ may have a single cylinder 68, if the piston assembly 70 is appropriately counter-weighted (not shown).

As with the exemplary embodiment of engine block 16, in FIGS. 8a, 8b, and 8c, the exemplary engine block 16′ may have cylinders 68 arranged around a cam crank 74. Other similar features may include a precisely patterned piston crank groove 76 formed into a surface of the cam crank 74, piston travelers 78 connected to the piston and positioned in a piston crank groove 76, and an alignment plate 84 with alignment channels 85, which may provide support against forces that may push on a piston assembly 70 outwardly of a desired position within the cylinder 68.

Fuel mixture may be channeled to a combustion chamber 72 via a respective intake channel 80. Similarly, the exhaust created by combustion may be channeled out of the combustion chamber 72 via a respective exhaust channel 82. Each intake channel 80 is in fluid communication with the fuel mixture intake orifice 32 and a respective combustion chamber 72. Similarly, each exhaust channel 82 is in fluid communication with a respective combustion chamber 72 and an exhaust orifice 38. It is appreciated that the engine 10 may be adapted with a fuel injection system (not shown), eliminating the need for the intake channel 80.

The exemplary engine block 16′ is cut through the pair of opposing cylinders 68 to show a piston assembly 70, combustion chamber 72, piston traveler 78, cylinder head 86, and an exemplary pair of spark plug wells 88 for each cylinder 68. Additionally, the illustration shows a cam crank 74 on shaft 22, in which is formed a piston crank groove 76. Similarly positioned on the shaft 22 as the cam crank 74 is an exemplary intake cam 90 toward the front of engine 10 from the cam crank 74, and an exemplary exhaust cam 92 toward the rear of the engine 10 from the cam crank 74.

Exemplary embodiment engine block 16′ may be air-cooled. Air may be directed through the cooling fins 59 to conduct thermal transfer. It is envisioned that as additional engine blocks 16′ may be modularly added to an opposed engine 10′ subsequent engine blocks 16′ may be elongated outwardly toward the cylinder head 86 in order to make cooling fins 59 of subsequent engine blocks 16′ gain access to fresh, unheated air. (Such configurations are shown later in this disclosure.)

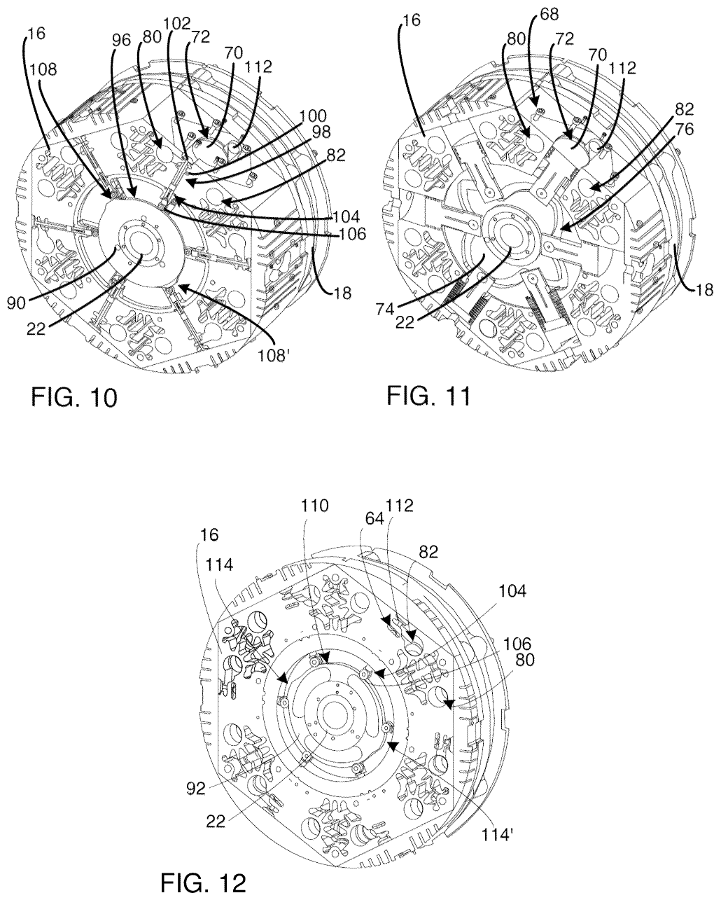

Focusing now on FIG. 10, a front portion of the engine block 16 is removed to expose an exemplary intake cam 90 mounted perpendicularly onto a shaft 22, and having an intake cam edge 96. This descripting will focus on a single one of the cylinders 68, but the components, features, and their operation and relationship are replicated in each individual cylinder 68. Also exposed is the valve assembly 98, which may be held in place in the engine block 16 by a valve retainer 100 inserted in a valve retainer slot 64. The exemplary valve assembly 98 may have an intake valve 102 at least partially positioned within the intake channel 80 to facilitate controlled entry of fuel mixture into a combustion chamber 72. The intake cam edge 96 may be precisely contoured to communicate the coordinated timing for each intake valve 102 to open and close. An exemplary hydraulic lifter 104 may be positioned intermediate the valve assembly 98 and the intake cam edge 96, with a lifter roller 106 pressed against the intake cam edge 96. An exemplary raised intake section 108 in the intake cam edge 96 will cause the hydraulic lifter 104 to lift the valve 102, to facilitate the flow of fuel mixture through intake channel 80 and into combustion chamber 72.

Focusing now on FIG. 11, a front portion of the engine block 16 is removed to expose an exemplary cam crank 74 mounted perpendicularly onto a shaft 22, and having a piston crank groove 76. Also exposed is a piston assembly 70 and a piston traveler 78, as well as a portion of the intake channel 80 and exhaust channel 82.

Focusing now on FIG. 12, a front portion of the engine block 16 is removed to expose an exemplary exhaust cam 92 mounted perpendicularly onto a shaft 22, and having an exhaust cam edge 110. A portion of the exemplary exhaust valve 112 is exposed, along with a portion of the exhaust channel 82. The configuration may be similar to the intake, in that an exhaust valve 112 may be at least partially positioned within the exhaust channel 82 to facilitate controlled exit of exhaust from a combustion chamber 72. The exhaust cam edge 110 may be precisely contoured to communicate the coordinated timing for each exhaust valve 112 to open and close. An exemplary hydraulic lifter 104 may be positioned intermediate the exhaust valve 112 and the exhaust cam edge 110, with a lifter roller 106 pressed against the exhaust cam edge 110. An exemplary raised exhaust section 114 in the exhaust cam edge 110 will cause the hydraulic lifter 104 to lift the exhaust valve 112, and facilitate a flow of spent fuel mixture through exhaust channel 82 and through the manifold 18.

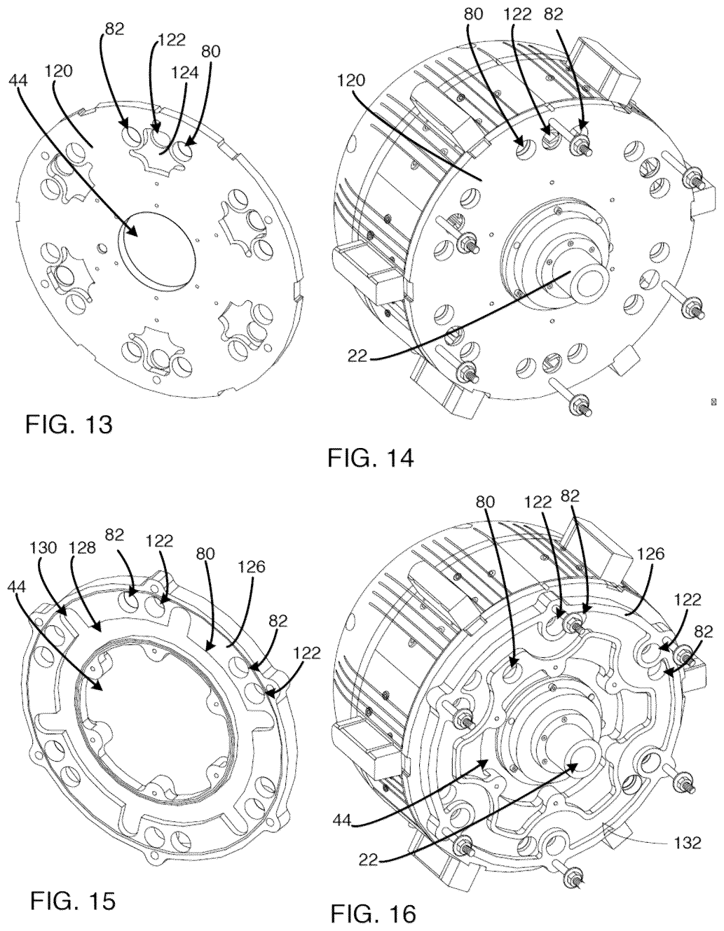

Referring now to FIGS. 13 through 20, components of the exemplary manifold 18, previously shown in FIGS. 2, 3, and 9, are shown in detail, separately and partially assembled to the exemplary engine 10. Exemplary manifold 18 has a generally cylindrical outer shape to correspond to the cylindrical shape of the exemplary engine block 16 for a radial embodiment of engine 10. It is appreciated that the exterior shape of the manifold 18 may correspond to the general exterior shape of alternate embodiments of the engine 10.

Focusing now on FIG. 13, the front side of an exemplary manifold rear mounting plate 120 is shown. The exemplary manifold rear mounting plate 120 may have a flat front side and a flat rear side, and an exterior shape similar to the general shape of the engine block 16 for which is it suited. With the exemplary radial design engine 10, the exterior shape is generally cylindrical. Each of the six cylinders 68 may have an intake channel 80, a coolant channel 122, and an exhaust channel 82. Additionally, the front side may have a coolant recess 124 surrounding the coolant channel 122, to facilitate distribution of coolant into the coolant jacket section 58 within the engine block 16. The manifold rear mounting plate 120 may be in direct contact with the engine block 16, and as such the seal between the engine block 16 and the manifold rear mounting plate 120 ensures fluids and gases within the engine stay contained. Now, also focusing on FIG. 14, the manifold rear mounting plate 120 is shown on the exemplary engine 10. A rear portion of the manifold 18 is removed to expose a rear side of an exemplary manifold rear mounting plate 120. It can be appreciated that parts in direct contact may have an intermediate gasket therebetween.

Focusing now on FIG. 15, the front side of an exemplary manifold channel plate 126 is shown to house the intake channel 80, the exhaust channel 82, and the coolant channel 122. The exemplary manifold channel plate 126 may have a flat front side and a flat rear side, and an exterior shape similar to the general shape of the engine block 16 for which is it suited. Additionally, the manifold channel plate 126 may have a central shaft hole 44 and an intake distribution channel 128. The shaft hole 44 allows for the shaft 22 to extend from the rear of the engine 10. The exemplary intake distribution channel 128 is oriented around the circumference of the shaft hole 44 of the front side of the manifold channel plate 126. A distribution channel finger 130 extends outwardly from the intake distribution channel 128 at each cylinder 68, to communicate the fuel mixture for a particular cylinder 68.

Focusing also now on FIG. 16, the rear side of the exemplary manifold channel plate 126 is shown to house the shaft hole 44, the intake channel 80, the exhaust channel 82, and the coolant channel 122. Additionally, an exhaust collection channel 132 may be oriented around the circumference of the shaft hole 44 of rear side of the manifold channel plate 126. An exhaust channel 82 from each cylinder 68 may feed into the exhaust collection channel 132.

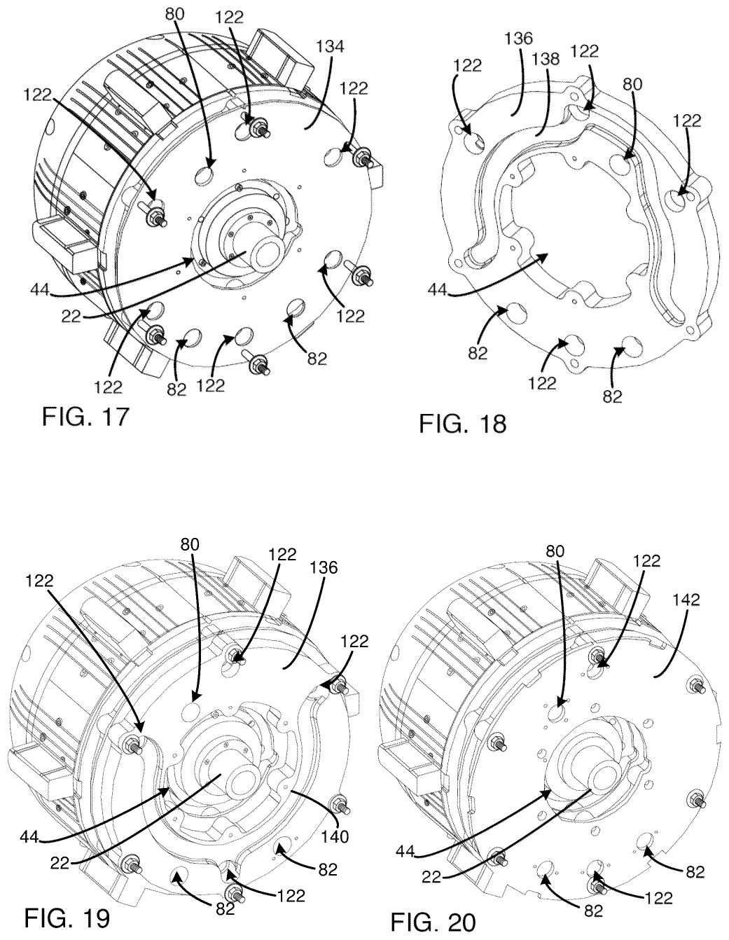

Focusing now on FIG. 17, the rear side of the exemplary manifold separation plate 134 is shown to have a central shaft hole 44, at least one intake channel 80, at least one exhaust channel 82, and a plurality of coolant channels 122. The exemplary manifold separation plate 134 may have a flat front side and a flat rear side, and an exterior shape similar to the general shape of the engine block 16 for which is it suited. In the exemplary embodiment, the manifold separation plate 134 covers the exhaust collection channel 132, and directs the communication of exhaust from an exhaust channel 82 for each cylinder 68 into a reduced number of exhaust channels 82 for controlled release from the engine 10. Controlled release may include noise muffling, emissions control, and providing power to a turbocharger.

Focusing now on FIG. 18, the front side of an exemplary coolant plate 136 is shown to house the intake channel 80, the exhaust channel 82, and the coolant channel 122. The exemplary manifold coolant plate 136 may have a flat front side and a flat rear side, and an exterior shape similar to the general shape of the engine block 16 for which is it suited. Additionally, the manifold coolant plate 136 may have a central shaft hole 44 and a coolant entry channel 138 along which coolant entering the engine is distributed from a single coolant channel 122 to multiple coolant channels 122 that lead to inlet coolant jacket sections 58. The shaft hole 44 allows for the shaft 22 to extend from the rear of the engine 10. The exemplary coolant entry channel 138 may be oriented partially around the circumference of the shaft hole 44 of the front side of the manifold coolant plate 136.

Focusing also now on FIG. 19, the rear side of the exemplary manifold coolant plate 136 is shown to house the shaft hole 44, the intake channel 80, the exhaust channel 82, and the coolant channel 122. Additionally, a coolant return channel 140 is oriented partially around the circumference of the shaft hole 44 of rear side of the manifold coolant plate 136. The coolant return channel 140 supports the consolidating communication of coolant (not shown) returning from the coolant jacket sections 58 of the engine block 16 from multiple coolant channels 122 to a single coolant channel 122. Consolidating coolant may facilitate coolant management, which may include filtering, heat dissipation, and pumping.

Focusing now on FIG. 20, an exemplary rear plate 142 is shown installed on the manifold coolant plate 136. The exemplary rear plate 142 is shown to house the shaft hole 44, the intake channel 80, the exhaust channel 82, and both an inlet and outlet of the coolant channel 122. The exemplary rear plate 142 may have a flat front side and a flat rear side, and an exterior shape similar to the general shape of the engine block 16 for which is it suited. In the exemplary embodiment, the rear plate 142 covers the coolant return channel 140, and seals the communication of coolant returning from the coolant jacket sections 58 of the engine block 16 from multiple coolant channels 122 to a single coolant channel 122.

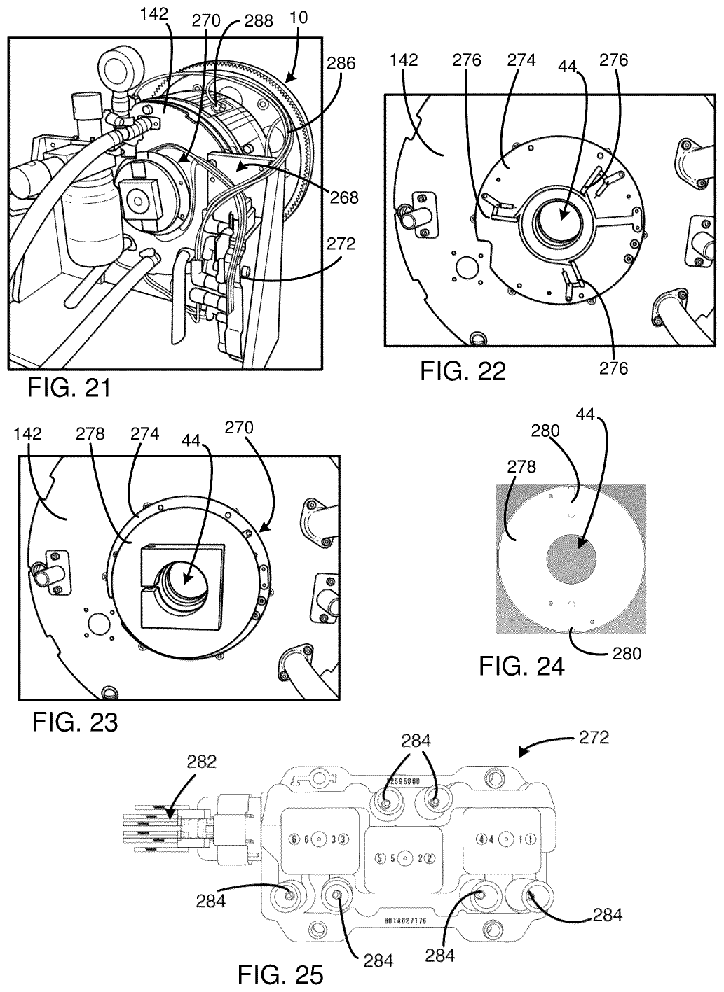

Referring now primarily to FIGS. 21 and 25, an exemplary ignition system 268 may include a trigger assembly 270, an integrated coil 272, and a set of spark plug wires 286. In the exemplary embodiment, the trigger assembly 270 may include a stator 274 and a rotor 278. The stator 274 and rotor 278 may each have a flat disk shape, with a shaft hole 44. In the exemplary embodiment, the rotor 278 may be attached to the shaft 22, perpendicular to the shaft 22, so as to rotate simultaneously with the shaft 22. In the exemplary embodiment, the stator 274 may be attached to the rear plate 142, perpendicular to the shaft 22, to remain rotatably stationary to the rear plate 142. The flat disk shape permits the stator 274 and rotor 278 to be positioned parallel to each other and near each other, and permit rotation of either the stator 274 or the rotor 278 without making contact with each other.

The exemplary stator 274 may have at least one trigger 276, with an open position, where electrical contact across the trigger 276 does not occur, and a closed position, where electrical contact across the trigger does occur. In the exemplary embodiment, the trigger 276 is moved from the open position to the closed position by being brought into a magnetic field. The exemplary rotor 278 may have at least one magnet 280 that may produce an appropriate magnetic field to effect movement in the trigger 276 between the open and closed positions. In the exemplary embodiment, the trigger 276 in the closed position may communicate an electrical signal to the integrated coil 272 through a control wire 282. The exemplary integrated coil 272 may create an electrical charge in response to such communication, and transmit the charge to a particular spark plug wire contact 284, which in turn would communicate the charge through the spark plug wires 286 to a particular spark plug 288, to ignite combustion in a particular combustion cylinder 68.

The exemplary ignition system 268 may be configured to induce two electrical charges per rotation of the rotor 278. In the exemplary embodiment, the integrated coil 272 may be configured so that one signal from a trigger 276 causes a charge to be communicated to two spark plug wire contacts 284, and therefore two cylinders 68, at the same time. Such an embodiment could require half as many triggers 276 cylinders 68 in the engine 10. Additionally, in the exemplary embodiment, the rotor 278 may have two magnets 280 positioned precisely opposite each other circumferentially on the rotor 278. Such an embodiment could move each trigger 276 from an open position to a closed position twice in each complete rotation of the rotor 278, resulting in one trigger 276 sending two signals to the integrated coil 272 for one rotation of the rotor 278. Such an engine 10 configuration may have half as many triggers 276 as cylinders 68. Such an engine 10 configuration may create two combustions per cylinder 68 per revolution of the shaft 22.

Applying the ignition system 268 configuration, where one signal from a trigger 276 causes a charge to be communicated to two spark plug wire contacts 284, to the exemplary engine 10 in FIG. 8a, may create neutral lateral forces on shaft 22 by coordinating the resulting simultaneous combustions in opposing cylinders 68. (In this disclosure, “lateral forces” is being used to mean any forces on the shaft 22 other than the desired rotational forces about the axis on which the shaft 22 intentionally turns.) In such an exemplary embodiment, forces, other than rotational, will occur in opposite pairs, and therefore offset. As seen in FIG. 8a, opposing piston assembly 70 may be coordinated to operate in the exact same cycle pattern, thereby precisely coordinating the simultaneous operation of opposing cylinders 68, and balancing lateral forces, created by combustion, on shaft 22.

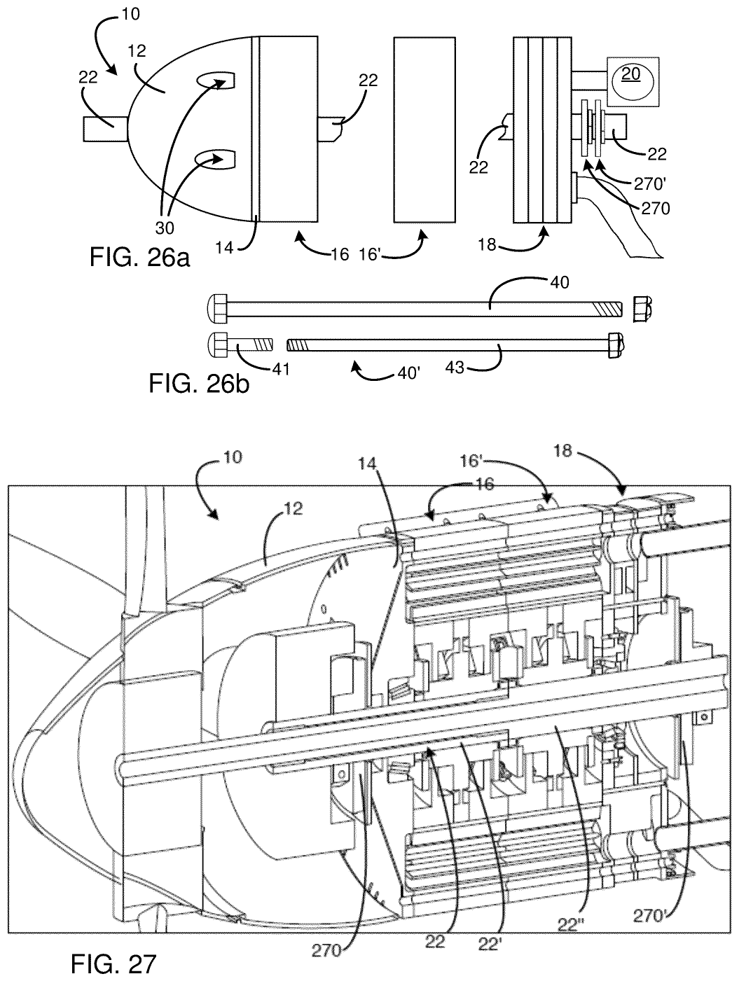

Referring now primarily to FIG. 26a, an exemplary engine 10 is shown in a partially exploded view in order to illustrate how the engine 10 may be expanded in size by adding an additional bank of cylinders 68. As previously shown, engine 10 may comprise a bell housing 12, a thrust bearing plate 14, and a first engine block 16, all mounted on a shaft 22. The modular design of the exemplary embodiment permits the addition of a supplemental engine bank 16′. In the exemplary embodiment, the supplemental engine bank 16′ may be inserted intermediate the first engine bank 16 and a manifold assembly 18. In the exemplary embodiment, each engine bank (16, 16′) may have a corresponding ignition trigger assembly (270, 270′).

Referring also now to FIG. 26b, the initial embodiment of exemplary engine bolts 40 are shown to be a single shaft adequate in length to extend through from the bell housing 12 through the manifold assembly 18. An alternate exemplary embodiment may include a 2-piece bolt assembly 40′, comprised of an initial securement bolt 41, and a rear bolt 43. In the exemplary embodiment, the initial securement bolt 41 secures the bell housing 12 to the thrust bearing plate 14 and the first engine block 16, and anchors into the engine block 16. In this embodiment, the initial securement bolt 41 may be threaded to be received by corresponding threads within the assembly bolt channel 30 of the first engine block 16. Rear bolt 43 may be inserted from the rear of the engine 10, securing the manifold assembly 18, and any supplemental engine blocks 16′, to the first engine block 16. Similarly to the initial securement bolt 41, rear bolt 43 may be threaded to be received by corresponding threads within the assembly bolt channel 30 of the first engine block 16. 2-piece bolt assembly 40′ may more appropriately provide for the modular expansion of engine 10 by reusing the initial securement bolt 41 when supplemental engine blocks 16′ are added to engine., the initial rear bolt 43 may be replaced with one of adequate length to support the additional engine 10 length created by the additional width of the supplemental engine block 16′.

Referring now primarily to FIG. 27, an alternate exemplary engine 10 is shown in a side view, cut-away through the shaft 22 axis in order to illustrate how the engine 10 may be configures with a supplemental engine block 16′ configured to be rotate counter to the original engine block 16. As previously shown, engine 10 may comprise a bell housing 12, a thrust bearing plate 14, and a first engine block 16, a supplemental engine block 16′, all mounted on a shaft 22.

In the exemplary embodiment, shaft 22 may have a first shaft segment 22′ and a second shaft segment 22″. In the exemplary embodiment, first shaft segment 22′ and a second shaft segment 22″ may be coaxial, and first shaft segment 22′ may be assembled to surround a portion of the second shaft segment 22″. In the exemplary embodiment, the first engine block 16 may be securable to the first shaft segment 22′, and a corresponding ignition trigger assembly 270 may also be attached to the first shaft segment 22′. In the exemplary embodiment, a supplemental engine block 16′ may be securable to a second shaft segment 22″, and a corresponding ignition trigger assembly 270′ may also be attached to the second shaft segment 22″. In this configuration, the first engine block 16 may power the rotation of the first shaft segment 22′ in one direction, with the ignition timing controlled by the first ignition trigger assembly 270, while the second engine block 16′ may power the rotation of the second shaft segment 22″ in the opposite direction, with the ignition timing of the second engine block 16′ controlled by the second ignition trigger assembly 270′.

In the shaft 22, the first shaft segment 22′ and a second shaft segment 22″ may be selectively linkable. In the event that one engine block (16, 16′) may fail, or be shut-down to conserve fuel, it may be advantageous to have a selectable linkage to power both the first shaft segment 22′ and a second shaft segment 22″, even if the two segments may be configured to rotate in opposite directions.

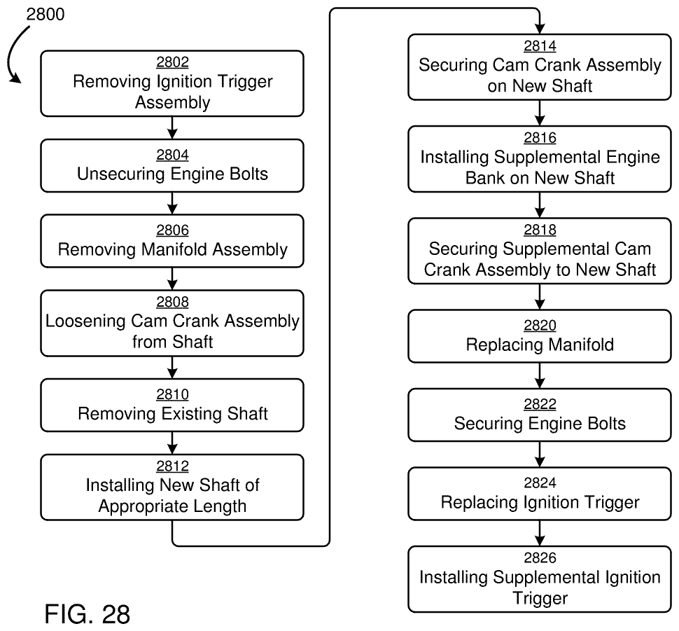

Referring now primarily to FIG. 28, an exemplary process for modularly expanding 2800 the engine 10 is shown to possibly consist of removing 2802 the existing ignition trigger assembly 250 from the rear of the shaft 22. This may allow for unsecuring 2804 the assembly bolts 40, which will permit removing 2806 the manifold assembly 18. In the exemplary embodiment, the initial shaft 22 is of proper length for an engine 10 with one (1) engine block 16. In order to accommodate the width of an additional engine block 16, a longer shaft 22 may be necessary. Removing 2810 the existing shaft 22 may be accomplished by loosening 2808 the cam crank assembly 75 from the shaft 22. In the exemplary embodiment loosening 2808 the cam crank assembly 75 may include loosening a plurality of securing bolts 94, which in turn will permit the tapered bushings 95 to reduce their impinging force applied to the shaft 22. The shaft 22 may then be removed from the engine 10 by sliding it along the shaft's 22 rotation axis. It can be appreciated that, in the exemplary embodiment, if the engine 10 to be expanded initially has more than one (1) engine block 16, each engine block 16 may be removed in sequence, from the rear of the engine 10, through repeated loosenings 2808 of each particular cam crank assembly 75.

With the existing shaft 22 removed, installing 2812 a new shaft 22 of appropriate length for the desired new engine 10 configuration may be accomplished. The new shaft 22 may be secured within the engine 10 by securing 2814 the original cam crank assembly 75 to the shaft 22 by tightening the securing bolts 94 against the tapered bushings 95, causing the tapered bushings 95 to impinge against the shaft 22.

With the new shaft 22 secured in the original engine block 16, installing 2816 a supplemental engine block 16′ may be accomplished. Securing 2818 the supplemental engine block 16′ on the new shaft may be accomplished in the same manner as securing 2814 the cam crank assembly 75 of the original engine block 16. In the exemplary embodiment, each engine block 16 or supplemental engine block 16′ may be secured to the shaft 22 in the same manner—by securing (4514, 2818) a respective cam crank assembly 75 to the shaft 22.

With the supplemental engine blocks 16′ secured on the shaft 22, replacing 2820 the manifold assembly 18 may be appropriate. The supplemented engine 10, with a new engine block 16 configuration, may then be unified by securing 2822 the engine bolts 40.

In the exemplary embodiment, a particular ignition triggers assembly 270 is used to time the firing sequence for a respective engine bank (16, 16′). In the exemplary embodiment, the ignition trigger assembly 270 for the original engine bank 16 comes first in order from the front to the rear of the engine 10, but the order needs not be critical, as long as the radial position of the ignition trigger assembly 270 is appropriate for the respective engine bank 16. In the exemplary embodiment, each engine block (16, 16′) align so that the cylinders from one engine block 16 radially align with cylinders from the supplemental engine block 16′. The differential in firing sequence is achieved by changing the radial positioning of the triggers 276 around the shaft 22 for each ignition trigger assembly 270.

In the exemplary embodiment, to keep the original ignition trigger assembly 270 in physical order with the original engine bank 16, replacing 2824 the original ignition trigger 270 may be accomplished before installing 2826 any supplemental ignition triggers 270′.

With a shaft 22 of appropriate length, additional engine blocks 16′ may be added to the engine 10. Exemplary manifold assembly 18 is configured to support multiple engine blocks 16. Additionally, each exemplary engine block 16 may incorporate intake channels 80 and exhaust channels 82 to support the additional modular engine blocks 16′ that the engine 10 may be able to possess.

Variations in the radial engine design may follow some suggestions for achieving favorable results. Pairs of opposing cylinders 68 may be sequenced to operate at identical combustion cycles by tuning the cam crank 74, intake cam 90, exhaust cam 92, and ignition system 268. The position of the cylinders 68 may be arranged in banks, each bank comprising a single engine block 16 and all the functional components contained therein, around the shaft 22. It is suggested to space the cylinders 68 evenly within each particular engine bank 16. For a balanced radial engine, determine the angle that achieves even spacing between the centerline of each cylinder in a bank divide 180 by one half the number of desired cylinders 68. This will provide the spacing of half of the cylinders in half of the bank. Position the other half of the cylinders precisely opposed to the first half of the cylinders.

When adding an additional bank of cylinders 68 to and engine 10, it is suggested that similarly sized engine blocks 16 be used, in order to provide consistent balance of the forces combustion within the cylinders 68 will apply to the engine 10. It is also suggested to offset the angle of firing the cylinders 68 in each bank of cylinders 68, so as to provide even power application throughout the rotational cycle of the shaft 22. The amount of the suggested offset of the firing sequence may be one half the spacing between the centerline of each cylinder 68 in the initial bank of cylinders 68. It is suggested that it may be desirable when adding additional engine blocks 16 to an engine 10, to adjust the firing of engine 10 as a whole to achieve even spacing of the firing sequences within the engine 10.

Though the radial spacing of the cylinders 16 within a bank of cylinders 68 is determined at the formation of the corresponding engine block 16, the modular nature of the current design enables an existing engine 10 to be supplemented with additional banks, by adding additional engine blocks 16. The angle of the firing sequence of a particular bank of cylinders 68 may be adjusted radially around the center shaft 22 to achieve a desirable radial cylinder 68 firing within the supplemented engine 10, and thereby desired power application to the shaft 22.

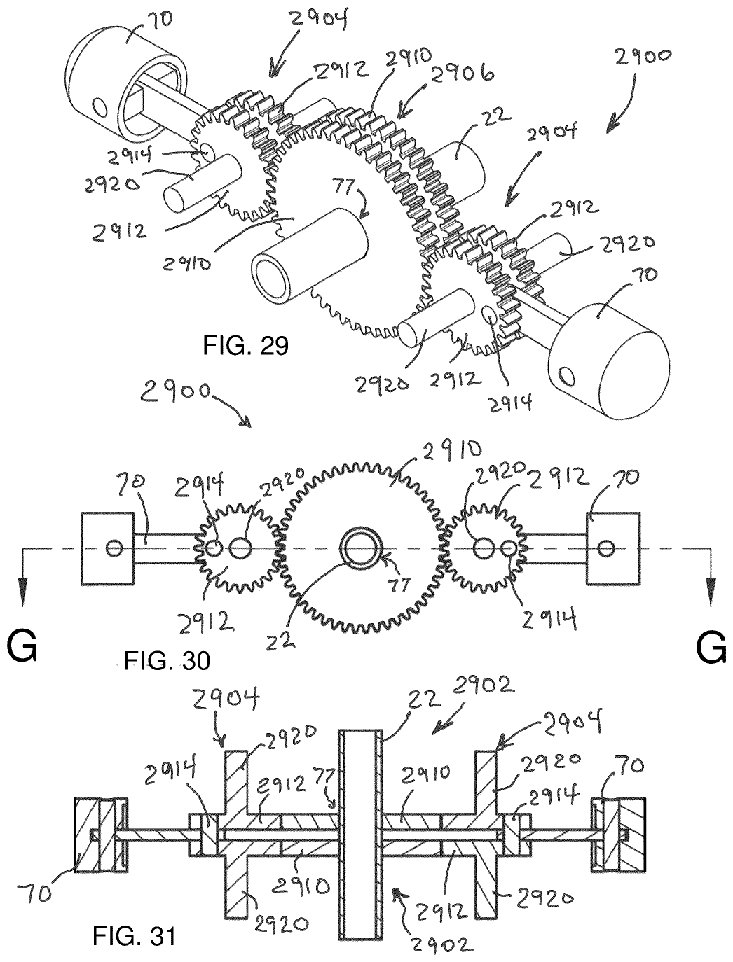

Referring now to FIGS. 29 through 34, exemplary embodiments of a planetary piston gear assembly 2900, a tandem planetary piston gear assembly 3200, a counter-rotated tandem planetary piston gear assembly 3300, and a radial planetary piston gear assembly 3400 are shown. In each of the exemplary embodiments, a planetary drive gear assembly 2906 may be comprised of a pair of drive gears 2910. An exemplary planetary drive gear assembly 2906 may replace a cam crank 74 in a cam crank assembly 75 to provide an alternate way to achieve multiple combustions in each combustion chamber 72 per rotation of the shaft 22. Alternatively, a planetary piston gear assembly 2900 may be used with a conventional cam and valve system.

In the exemplary planetary piston gear assembly 2900, a central planetary drive gear 2910 may be rotationally attached to shaft 22 so as to rotate in conjunction with shaft 22. In an exemplary embodiment, the central planetary drive gear 2910 may be removably secured to shaft 22 with an exemplary shaft securement assembly 77, as depicted and described in detail previously, as in FIG. 8e. Each piston assembly 70 may be linked to a piston gear assembly 2904, which in the exemplary embodiment may comprise a pair of piston gears 2912, each rotationally secured to a piston gear shaft 2920. The piston assembly 70 may be secured to the pair of piston gears 2912 with a piston assembly pin 2914 that secures a portion of the piston assembly 70 intermediate the individual piston gears 2912. The piston gears 2912 may interface with the drive gears 2910 such that rotation in either the piston gears 2912 or the drive gear 2910 imparts rotation in the other.

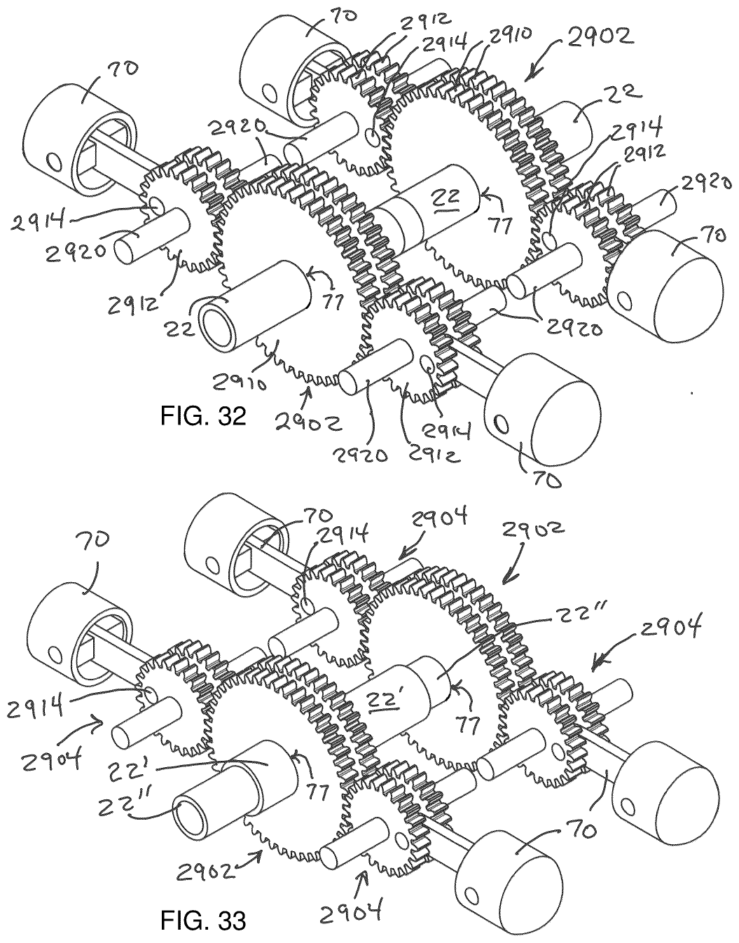

Referring now more particularly to FIG. 32, a tandem planetary piston gear assembly 3200 is shown to comprise the components of a pair of planetary piston gear assembly 2900. Referring now more particularly to FIG. 32, a counter-rotated tandem planetary piston gear assembly 3300 is similarly shown to comprise the components of a pair of planetary piston gear assembly 2900. One may appreciate that multiple planetary piston gear assemblies 2900 may be converted into a tandem planetary piston gear assembly 3200 or counter-rotated piston gear assembly 3300 in a similar fashion as the cam crank engine 10 shown in FIG. 26a. Additionally, the exemplary process for modularly expanding 2800 the engine 10 may be adapted to similarly modularly expand the planetary piston gear assembly 2900 into a tandem planetary piston gear assembly 3200 or counter-rotated piston gear assembly 3300.

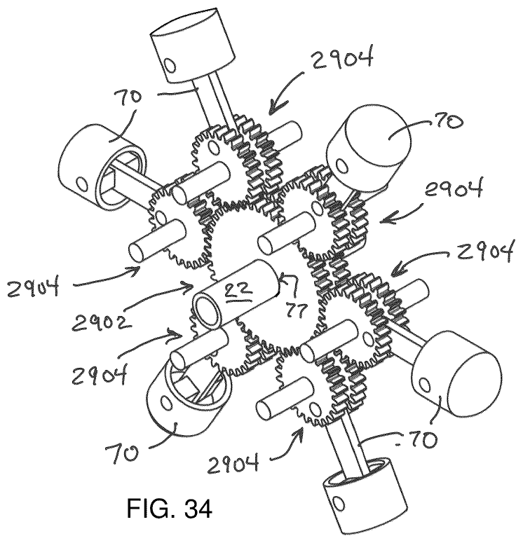

Referring now more particularly to FIG. 34, a radial planetary piston gear assembly 3400 is shown. Such a radial planetary piston gear assembly 3400 may be similarly, modularly configured into a tandem or counter-rotated tandem configuration within the scope of this disclosure. The particular exemplary embodiment of the radial planetary piston gear assembly 3400 depicts that piston assemblies 70 all at top dead center, it is envisioned and preferred to sequence the stoke of the piston assemblies such that individual piston assemblies or opposed pairs of piston assemblies are staggered in their combustion cycles. As in a standard engine convention, “top” is in reference to the top-most portion of a combustion chamber, where the size of the combustion chamber is the smallest.

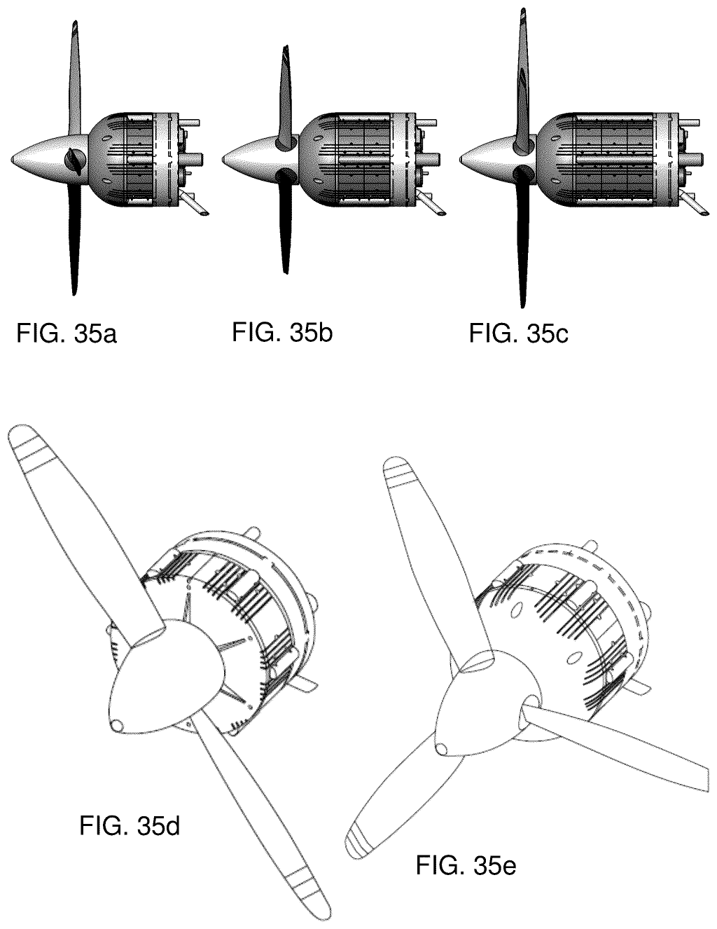

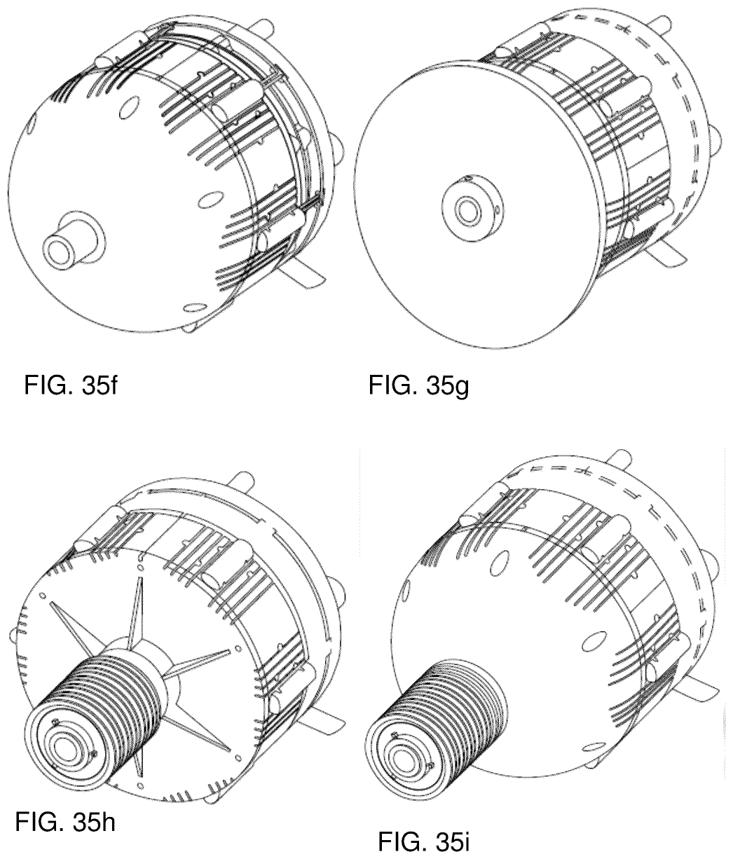

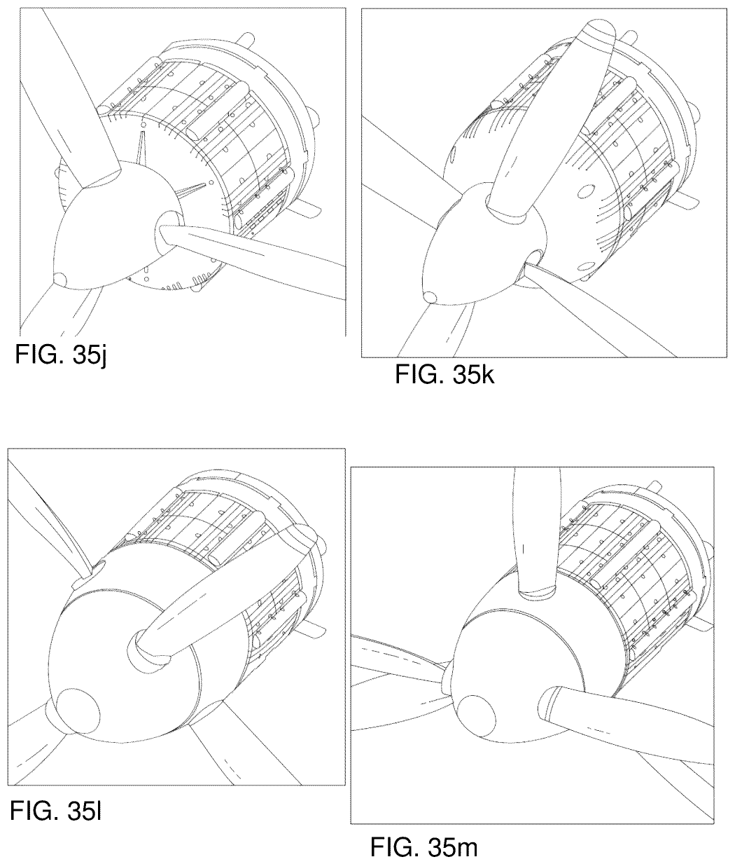

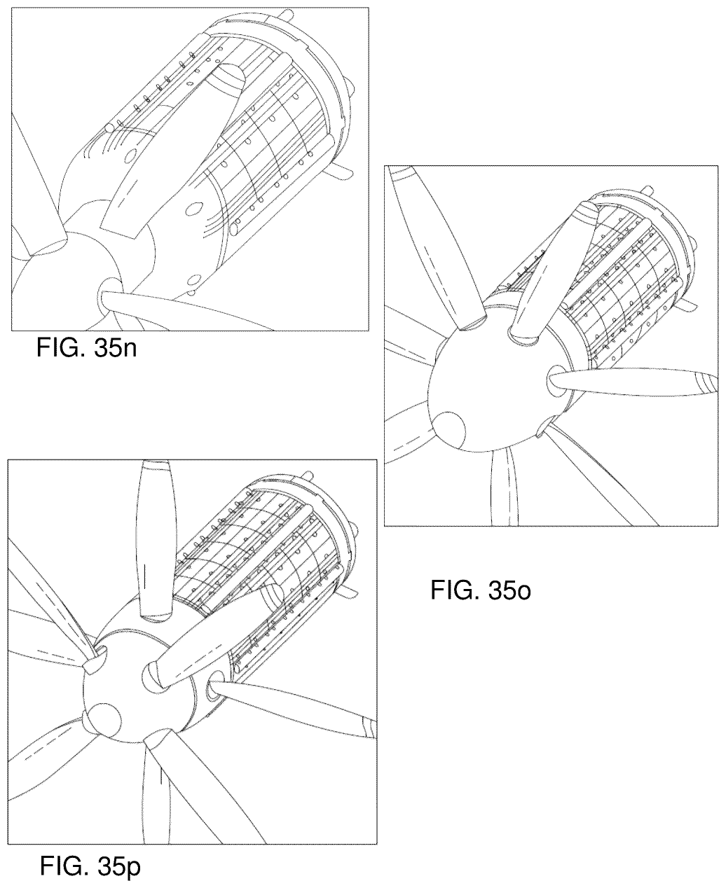

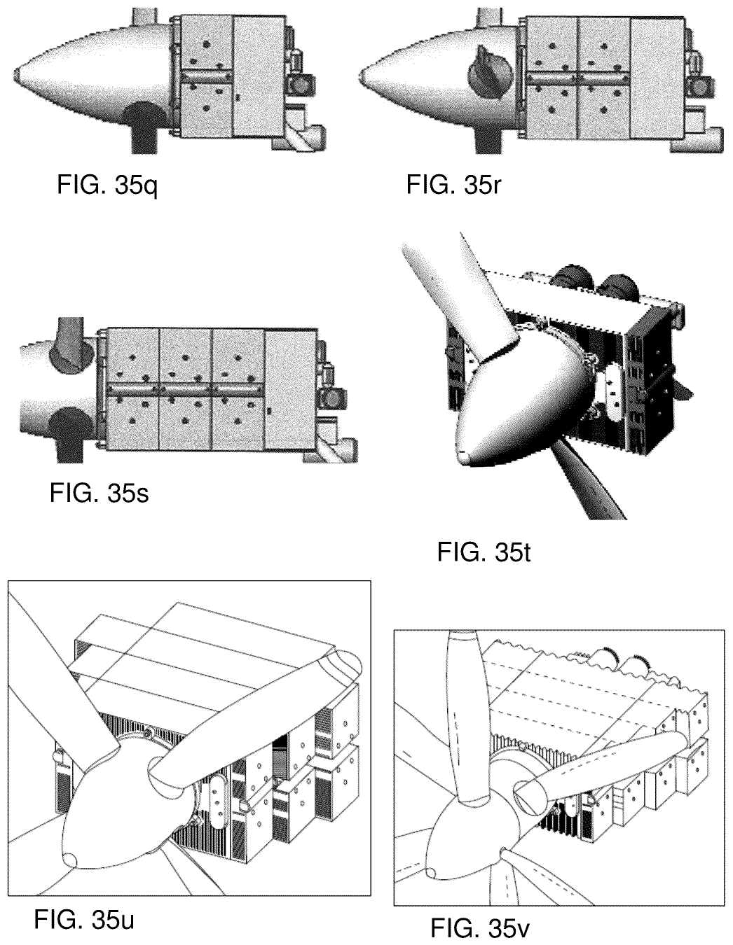

Referring now primarily to FIGS. 35a through 35v, various engine configurations are shown. The configurations may vary in a number of ways, including the number of banks of cylinders 68, the configuration of the cylinders 68, such as radial or opposed, and the propeller blade configurations. Propellers may vary in number, in number of banks, and in the counter-rotation of banks of propellers. Additionally, because of the configuration of the current design, a specific bank of propellers may be driven by a particular engine bank, or set of engine banks. Additionally, the drive shaft may be configured to have multiple coaxial drive shafts connecting a particular propeller bank to a particular engine bank. Further, a particular propeller bank may rotate opposite to another propeller bank (counter-rotate) in the same engine 10, since the coaxial connection between distinct engine banks may support such counter-rotation.

FIGS. 35a through 35c show a side-by-side comparison of an exemplary engine in a radial configuration, with one engine bank, two engine banks, and three engine banks, respectively. FIG. 35d shows a single-engine-bank engine configured as a direct drive power source to a propeller set. FIG. 35e shows a single-engine-bank engine configured with a bell housing 12, in which a set of reduction gearing may be housed intermediate the engine 10 and a propeller set.

FIG. 35f shows a single-engine-bank engine configured as with a bell housing 12, in which a set of reduction gearing may be housed. FIG. 35g shows a single-engine-bank engine configured as with a flywheel. Such a configuration may permit the engine bank 16 to comprise a single cylinder 68, since the flywheel may carry the combustion cycle over inflection points in the power generation cycle. FIG. 35h shows a single-engine-bank engine configured as with a drive pulley output for the transmission of power from the engine to operate machinery. FIG. 35i shows a single-engine-bank engine configured as with a drive pulley output, and configured with a bell housing 12, in which a set of reduction gearing may be housed intermediate the engine 10 and a pulley.

FIG. 35j shows a dual-engine-bank engine configured as a direct drive power source to a propeller set. FIG. 35k shows a single-engine-bank engine configured with a bell housing 12, in which a set of reduction gearing may be housed intermediate the engine 10 and a propeller set. FIG. 351l shows a dual-engine-bank engine configured with two propeller sets. The illustrated propeller sets are configured to counter-rotate. This can be accomplished by coaxial shafts directly linking a particular engine bank (16, 16′) to a particular propeller. For counter-rotation, the respective engine banks may be configured to rotate in opposite directions. Similarly, the propeller sets could be configured to rotate the same direction. This may still employ coaxial shafts 22, but the engine blocks could operate in the same rotational direction.

FIG. 35m shows a triple-engine-bank engine configured with two propeller sets. The illustrated propeller sets are configured to counter-rotate. FIG. 35n shows a quadruple-engine-bank engine configured with two propeller sets. The illustrated propeller sets are configured to rotate in the same direction. FIG. 35o shows a quintuple-engine-bank engine configured with a single propeller set. FIG. 35p shows a sextuple-engine-bank engine configured with two counter-rotational propeller sets.

FIG. 35q through 35s show a side-by-side comparison of an exemplary engine in an opposed configuration, with one engine bank, two engine banks, and three engine banks, respectively, with housings over the manifold assemblies 18. FIG. 35t shows a single-engine-bank opposed engine configured as a direct drive power source to a propeller set. FIG. 35u shows a triple-engine-bank opposed engine, with a housing over the manifold assembly 18, configured as a direct drive power source to a propeller set. FIG. 35v shows a quadruple-engine-bank opposed engine with two sets of propellers, configured to rotate in the same direction. This exemplary embodiment is shown with room for a reduction gear set intermediate the first engine block 16 and the propeller sets.

The examples contained in this specification are merely possible implementations of the current system, and alternatives to the particular features, elements and process steps, including scope and sequence of the steps may be changed without departing from the spirit of the invention. The present invention should only be limited by the examined and allowed claims, and their legal equivalents, since the provided exemplary embodiments are only examples of how the invention may be employed, and are not exhaustive.

I claim:

1. An internal combustion engine, comprising:
at least one engine block;
said at least one engine block comprising at least one piston in a combustion chamber;
a cam crank assembly connectable to a crank shaft;
the cam crank assembly having a planetary gear assembly, an intake cam and an exhaust cam;
the planetary gear assembly having a drive gear rotationally secureable to the crank shaft, a piston gear rotationally engaged with the drive gear, and a piston assembly rotationally attached to the drive gear.
